(19) United States
(12) Patent Application Publication
(10) Pub. No.: US 2024/0404378 A1
(43) Pub. Date: Dec. 5, 2024

(54) CABLE LOCKING SYSTEM WITH OPTICAL FIBER ACTUATION

(71) Applicant: Lenovo (Singapore) Pte. Ltd., Singapore (SG)

(72) Inventors: Arthur Arruda, Morrisville, NC (US); Hildebrando Lima, Carapicuiba - SP (BR)

(21) Appl. No.: 18/328,003

(22) Filed: Jun. 2, 2023

(51) Int. Cl. G08B 13/12; E05B 73/00; G06F 21/88; G08B 13/186

(52) U.S. Cl. CPC G08B 13/12; E05B 73/0082; G06F 21/88; G08B 13/186

(57) ABSTRACT

A theft protection system for a device includes a cable having an inner optical waveguide and first and second ends, a locking mechanism to releasably securing the cable to the device and align the first end of the cable to a light emitter in the device and to align the second end of the cable to a light detector in the device such that severing the cable interrupts light transmission via the optical waveguide between the light emitter and light detector.

### BACKGROUND

Valuable assets, such as computers or other devices may be secured to a larger object, such as a table via a cable. The cable physically retains the asset, making it more difficult to steal. However, cables can be easily severed by a cable cutter, splicer or saw, allowing theft of the asset.

### SUMMARY

A theft protection system for a device includes a cable having an inner optical waveguide and first and second ends, a locking mechanism to releasably securing the cable to the device and align the first end of the cable to a light emitter in the device and to align the second end of the cable to a light detector in the device such that severing the cable interrupts light transmission via the optical waveguide between the light emitter and light detector.

### BRIEF DESCRIPTION OF THE DRAWINGS

FIG. 1A is a block diagram of a theft protection system for an asset, such as an electronic device according to an example embodiment.

FIG. 1B is a block diagram of an alternative example theft protection system according to an example embodiment.

FIG. 1C is a block diagram of an alternative cable arrangement for the theft protection system according to an example embodiment.

FIG. 1D is a block diagram of an alternative method of coupling the cable according to an example embodiment.

FIG. 2 is a cross section of block representation of a further example theft protection system according to an example embodiment.

FIG. 3 is a perspective block diagram view of a locking mechanism according to an example embodiment.

FIGS. 4A and 4B illustrate respective locked and unlocked positions of bolts and latches actuated by turning a key in keyed cylinder according to an example embodiment.

FIGS. 5A and 5B are cross sectional views of a locking mechanism in respective locked and unlocked positions according to an example embodiment.

FIG. 6 is a cross section of a cable illustrating connection to a bolt according to an example embodiment.

FIG. 7 is a flowchart illustrating a method of detecting severing of a cable having an optical fiber according to an example embodiment.

FIG. 8 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

An improved cable locking system includes a cable with an optical fiber enclosed in the cable. The cable is locked to an asset, such as a computer case or cabinet, and secured to a larger object to prevent theft of the asset. The optical fiber forms a light path between a light source or emitter and a light detector or receiver supported by the object. Severing of the cable interrupts the light path and triggers a theft warning signal. The theft warning signal may be used to trigger one or more selected actions, such as generating an audible alarm, sending electronic communications, protecting or erasing data stored on the asset, or triggering a location tracking signal.

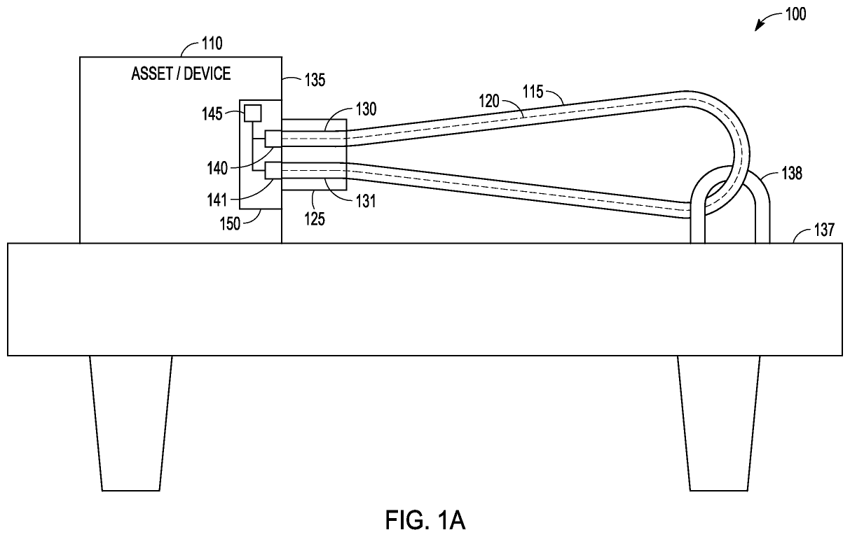

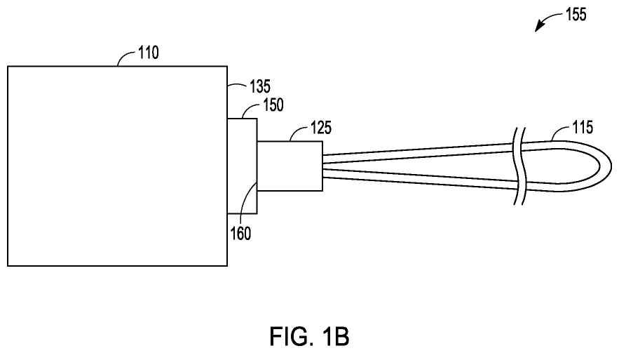

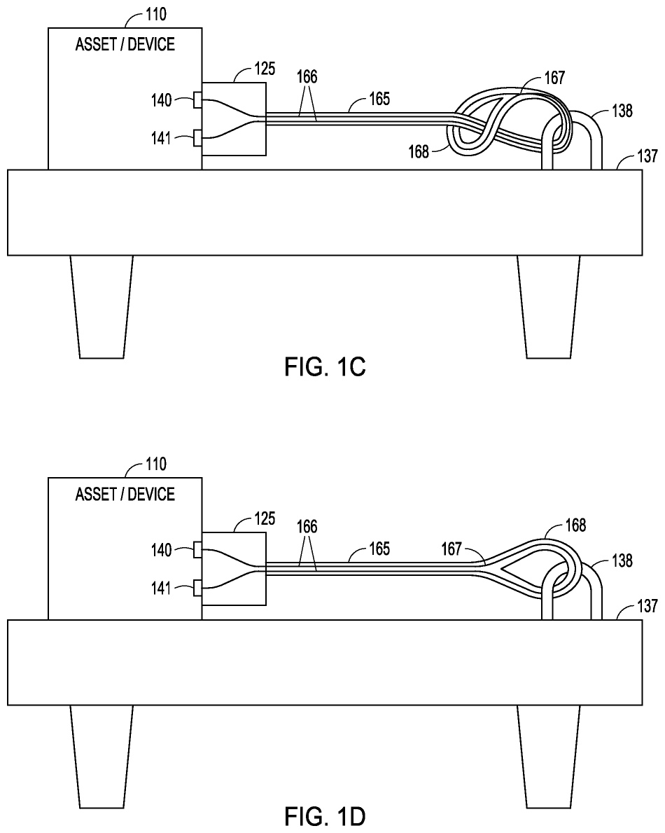

FIG. 1A is a block diagram of a theft protection system 100 for an asset, such as an electronic device 110. Reference numbers in the various figures may be used for similar components or elements in different figures for convenience of illustration and understanding. A cable 115 having an inner optical waveguide 120 is coupled to a locking mechanism 125. Locking mechanism 125 releasably securing a first cable end 130 and a second cable end 131 of the cable 115 to a chassis 135 of device 110. The cable 115 may be coupled to an object 137, such as a heavy table, or wall, or other object that makes it difficult to move unnoticed, thus acting as a deterrent to theft of the device 110. A U-bolt 138 that is coupled to the object 137 may be used to couple the cable to the object 137 in one example. Other means for coupling the cable 115 to the object 137 may be used in further examples, such that the cable is securely coupled to the object 137.

The locking mechanism 125 aligns the optical waveguide in the first cable end 130 to a light emitter 140, such as a light emitting diode, in the device and aligns the second cable end 131 to a light detector 141 in the device 110. Such alignment may be obtained by keying the locking mechanism 125 to the device 110 and results in the optical waveguide 120 being optically coupled to the light emitter 140 and light detector 141. Severing the cable 115 also severs the optical waveguide 120 and interrupts light transmission via the optical waveguide 120.

Connections of the optical waveguide, such as an optical fiber to the light emitter 140 and light detector 141 may be done by aligning ends of the optical fiber with light emitting and receiving surfaces of the light emitter 140 and light detector 141.

Interruption of light transmission is detected by the light detector 141, such as a phototransistor, no longer being activated by the light. The absence of light at the light detector 141 is detected via circuitry 145, which generates a warning signal indicating that light is no longer detected. Circuitry 145 may include a microprocessor in one example that both receives a light detected signal from light detector 141 while light is present, and generates the warning signal in the absence of the light detected signal.

In one example that light emitter 140, light detector 141, and circuitry 145 may be disposed within the chassis 135 and optionally enclosed in a container 150 that is supported within the chassis.

FIG. 1B is a block diagram of an alternative example theft protection system 155 where the container 150, including the light emitter 140, light detector 141, and circuitry 145. is mounted to an outside surface of the device chassis 135 such as by bolts, welding, or other means for securing the container 150 to the chassis 135. The locking mechanism 125 abuts and locks to an internal wall 160 of the container 150 to optically align the cable 115 and optical waveguide to the light emitter 140 and light detector 141. Circuitry 145 in system 155 may be coupled to device circuitry to perform one or more actions requiring action of the device. Circuitry 145 may also include wireless network connection capabilities to perform actions directly.

FIG. 1C is a block diagram of an alternative cable arrangement for the theft protection system 155. A cable 165 includes a waveguide in the form of an optical fiber 166, and attaches to the locking mechanism 125. The optical fiber forms a loop within the cable 165, with ends coupling to the light emitter 140 and light detector 141. The cable 165 contains both ends, and splits at a crimped portion 167 into a loop 168, with the different ends of the optical fiber 166 looping along with loop 168. In one example, the cable 165 is first inserted through the U-bolt 138, then through the loop 168, and finally locked to the locking mechanism 125 to secure the device 110 to the U-bolt. The point at which cable 165 connects to the locking mechanism 125 comprises both ends of the cable 165 and optical fiber 166.

FIG. 1D is a block diagram of an alternative method of coupling the device 110 to the U-bolt 138 by simply forming the cable 165 loop through the U-bolt 138. The cable 165 loop is reconnected at crimped portion 167 and proceeds back to couple to the locking mechanism 125. The device 110 will then be secured by locking the locking mechanism 125 to the device 110.

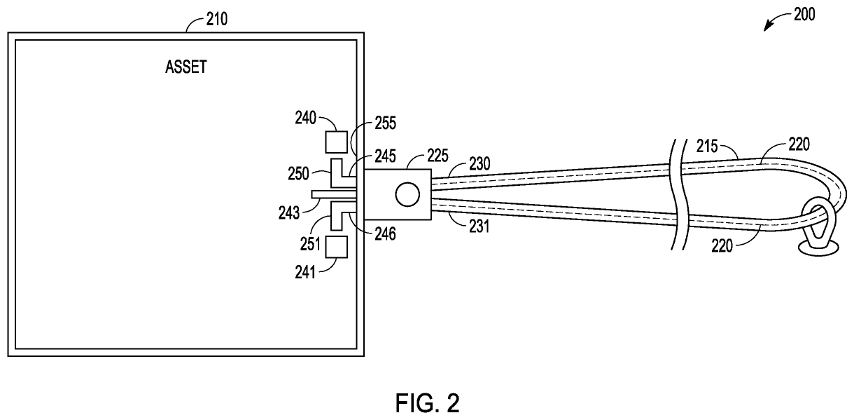

FIG. 2 is a cross section of block representation of a further example theft protection system 200 for an asset, such as an electronic device 210. A cable 215 having an inner optical waveguide 220 is coupled to a locking mechanism 225. Locking mechanism 225 releasably secures a first cable end 230 and a second cable end 231 of the cable 215 to a chassis 235 of device 210. The cable 215 may be suitable for coupling to an object, such as a heavy table, or wall, or other object that makes it difficult to move unnoticed, thus acting as a deterrent to theft of the device 210.

The locking mechanism 225 aligns the optical waveguide 220 in the first cable end 230 to a light emitter 240 in the device 210 and aligns the second cable end 231 to a light detector 241 in the device 210. An optical insulator 243 may be supported between the light emitter 240 and light detector 241 to block light from the light emitter 240 from directly propagating to the light detector 241. The optical insulator 243 may be an opaque planar material, such as metal, plastic, word or other material operating as a means for blocking light.

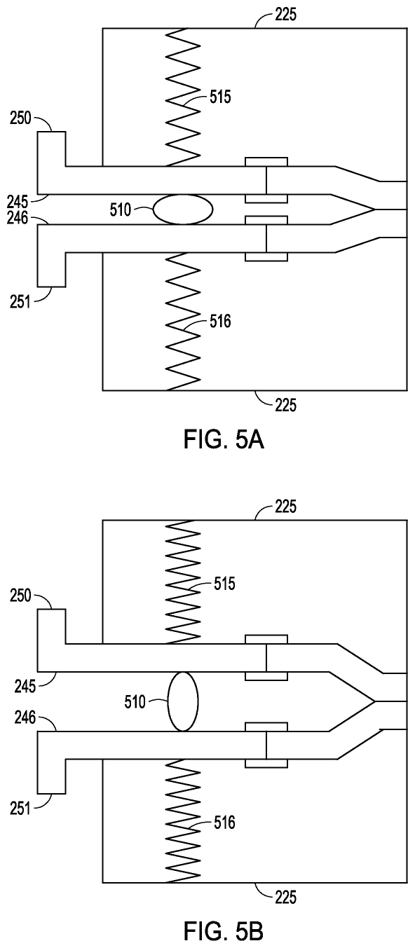

In one example, each end of the cable is crimped onto a bolt 245, 246 have a latch 250, 251 extending laterally from the bolt as shown in further detail in FIG. 5. The bolts 245, 246 attached to each of the respective cable ends 230 and 231, which extend through locking mechanism 225. When locked into position, the bolts are separated laterally, such that the latch 250 and 251 engage with an inner surface 255 of the chassis 235 to lock the cable 215 to the device 210. The optical waveguide continues through the bolt and latch portions of the cable to be optically aligned with the light emitter 240 and light detector 241 in the locked position. Unlocking of the cable forces the bolts laterally toward each other, releasing the locking mechanism 225 from the chassis. In one example, unlocking of the cable allows at least one end of the cable to release from the locking mechanism 225. allowing detachment of the cable from the object. Severing the cable 215 also severs the optical waveguide 220 and interrupts light transmission via the optical waveguide 220.

Interruption of light transmission is detected by the light detector 241, such as a photo diode, no longer being activated by the light. The light detector 241 generates an electrical signal representative of light being received or not received, which may be translated to logic level signals for further processing. The absence of light at the light detector 241 results in a representative logic signal that is coupled to circuitry 260, which generates a warning signal indicating that light is no longer detected. Circuitry 260 may be a microprocessor in one example that both receives a light detected signal from light detector 241 while light is present, and generates the warning signal in the absence of the light detected signal.

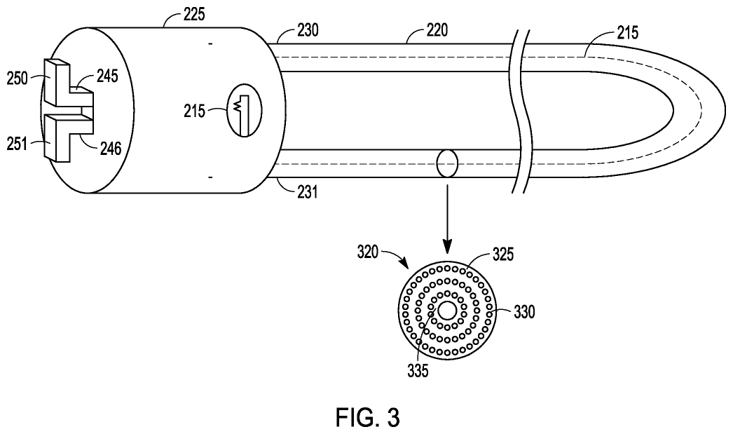

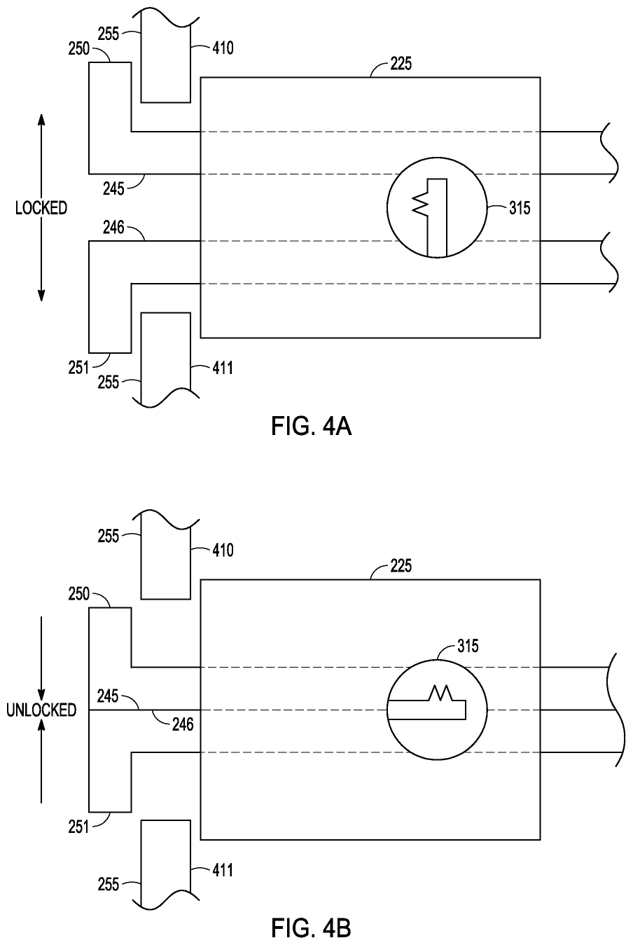

FIG. 3 is a perspective block diagram view of locking mechanism 225 along with cable 115 and optical waveguide 120 showing the bolts 245, 246 and latches 250, 251 in a locked position. The bolts 245, 246 and latches 250, 251 extend through an opening 310 to engage with the device 210 through a corresponding opening that is sized to admit the bolts and latches in an unlocked position as shown in further detail in FIGS. 4A and 4B.

Locking mechanism 225 in one example includes a keyed cylinder 315 which operates to laterally move the bolts into the open and closed position. Any type locking mechanism may be used as a means for locking and unlocking in further examples to releasably retain the cable to the device. In one example, the bolts may be spring loaded in an open position, with the springs forcing the bolts together. Actuating the keyed cylinder by rotating in response to a suitable key being inserted and turned causes a wedge, not shown, to force the bolts apart into a locked position. In further examples, the bolts may be directly moved together and apart by rotation much like a dead bolt in a deadbolt lock.

Further detail of an example cable is shown a cable cross section at 320. The cable may include multiple carbon steel strands 325 enclosed in a shell 330, with the strands 325 arranged around and supporting the optical waveguide comprising an optical fiber 335. Other arrangements and materials for cable 115 may be used in further examples so long as it is reasonably difficult to sever the cable or severing the cable cannot be easily done while maintaining optical transmission via the optical fiber 335. Cable 166 and loop 168 may be formed by simply positioning the cable 220 to form a loop 168 with the remaining ends of the cable 220 being adjacent to each other and then coating the cable 220 with shell 330.

FIG. 4A and FIG. 4B illustrate respective locked and unlocked positions of bolts 245, 246 and latches 250, 251 actuated by turning a key in keyed cylinder 315. FIG. 4A illustrates the locked position, with latches 250 and 251 engaging portions of the chassis 235 indicated at 410 and 411 respectively. Bolts 245 and 246 are laterally separated via the key cylinder.

FIG. 4B illustrates the unlocked position with the bolts 245 and 246 brought laterally together, disengaging the latches 250 and 251 from the portions potions 410 and 411. The portions 410 and 411 of the chassis 235 are separated to form an opening 415 through the chassis, allowing the locking mechanism 225 to be removed. In one example, the optical insulator 243 is sufficiently thin to ensure the locking mechanism 225 can be removed from the chassis.

FIG. 5A is a cross sectional view of the locking mechanism 225 in a locked position. A lever 510 is coupled to keyed cylinder 315. The lever 510 rotates in response to a key turning within keyed cylinder 315. The lever 510 is shown with the locking mechanism 225 in a locked position. The lever 510 levers the bolts 245 and 246 apart and compresses respective springs 515 and 516. In one example the lever may be an oblong oval or racetrack shape having at least one long side and at least one shorter side to facilitate rotation of the lever with turning the key and actuation of the bolts 245 and 246. The lever 510 is shown in vertical position, with the long sides forcing the bolts 245 and 246 apart.

FIG. 5B is a cross sectional view of the locking mechanism 225 in an unlocked position. The lever 510 is shown with the short sides spacing the bolts 245 and 246 which are biased together by springs 515 and 516.

In one example, the cable 220 is flexible. As shown in FIGS. 5A and 5B, the cables exit the locking mechanism 225 at the same point by bending to accommodate the locked and unlocked positions of the latches 250 and 251. In further examples, an opening in the locking mechanism 225 is large enough to permit separation of the cables while in the locked position. Suitable barriers may be formed within the locking mechanism to prevent interference with the keyed cylinder 315, springs 515, 516, and lever 510.

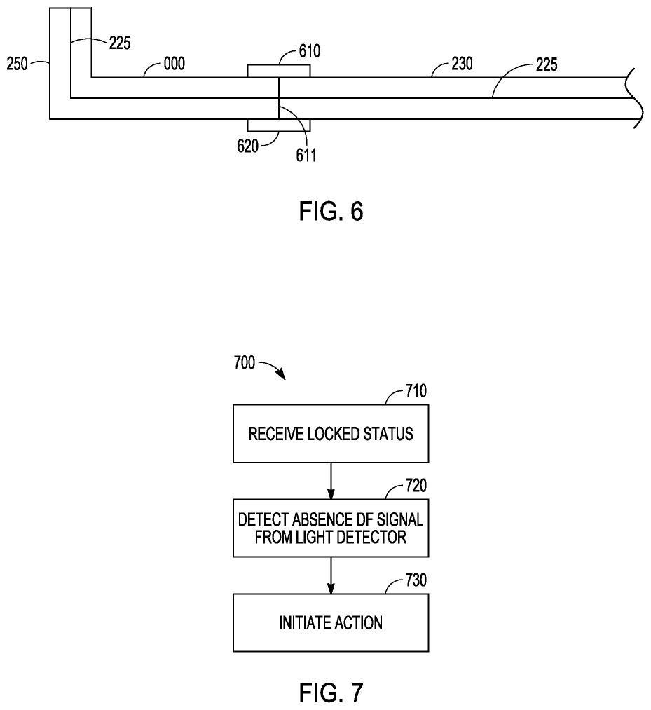

FIG. 6 is a cross section of a cable 220 illustrating connection to bolt 245. Cable 220 may be connected to bolt 245 in the same manner. In one example, each end of the cable is crimped via a connector 610, 611 onto a bolt 245, 246 have a latch 250, 251 extending laterally from the bolt 245. The optical fiber 215 is either continuous where the end of the cable meets the bolt at 620, or is optically coupled to an optical fiber disposed within the bolt 245 and latch 250. The bolt and latch may be formed of metal or other material that provides structural integrity suitable for protecting a device from being easily stolen. Holes may be drilled into the bolt 245 and latch 250 for threading the optical fiber 215 through the bolt 245 and latch 250.

In one example the locking bolts 245 and 246 extend orthogonal to the locking mechanism and are insertable into an opening of the chassis of the device in an unlocked position, and including latching portions extending laterally from each other and moveable laterally to expand beyond the opening of the chassis of the device to lock the locking mechanism to the chassis of the device.

FIG. 7 is a flowchart illustrating a method 700 performed by the circuitry 145. Method 700 begins at operation 710 by receiving a locked status indicating the locking mechanism is secured to the device. The locked status may be received by detecting light at the light detector 241 corresponding to the locking mechanism being locked in place such that the light emitter 240 and light detector 241 are aligned and optically coupled to the optical fiber 215. In further examples, a user interface may be used to inform that device and circuitry that the locking mechanism is locked by the user selecting a request for initiating locking software. Once the light is detected by the light emitter, the locked status is generated via the software and received.

In response to the cable being cut or otherwise severed, operation 720 detects the absence of a signal from the light detector. Operation 730 performs and action in response to detecting the absence of a signal from the light detector. Performing an action in response to detecting the absence of a signal may include one or more of sounding an alarm, transmitting an alarm message, initiating a data protection action of encrypting data stored on the device, or destroying the data stored on the device. The actions may be performed by the circuitry 145 or other circuitry within the device being protected.

The user interface may also include a selection for a user to indicate that the locking mechanism is being unlocked. Once selected, removing the cable or cutting the cable will not result in actions being performed. Method 700 operations may be performed in circuitry that is part of a device, or by circuitry added to the device for performing one or more operations of method 700, or by a combination of both.

The optical waveguide based theft protection system may have one or more advantages over radio/electrical locking that can be more easily circumvented. The optical waveguide based theft protection system may be used with an out-of-band supervisor system present in some x86 processors. In IT maintainer can either scan over all the locked assets or be informed via actions performed in method 700 even if the device, such as a computer system is not running an operating system. The user interface may be configured to ask a user of the device if the lock was removed and to confirm removal by means of a password. If the password is successfully entered, no event is logged.

Alerts/actions might be configured by an IT maintainer depending of the user profile. The optical waveguide based theft protection system can be used to protect on desktop computers, notebook, monitors, and other assets.

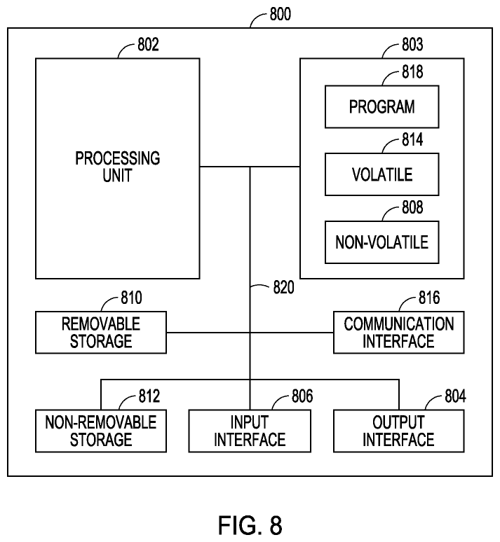

FIG. 8 is a block schematic diagram of a computer system 800 to receive and process signals for performing actions and operations and other methods and algorithms according to example embodiments. All components need not be used in various embodiments, as many of the operations may be performed by discrete programmed electronic circuitry.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, smart storage device (SSD), or other computing device including the same or similar elements as illustrated and described with regard to FIG. 8. Devices, such as smartphones, tablets, and smartwatches, are generally collectively referred to as mobile devices or user equipment.

Although the various data storage elements are illustrated as part of the computer 800, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input interface 806, output interface 804, and a communication interface 816. Output interface 804 may include a display device, such as a touchscreen, that also may serve as an input device. The input interface 806 may include one or more of a touchscreen, touchpad, mouse, keyboard, camera, one or more device-specific buttons, one or more sensors integrated within or coupled via wired or wireless data connections to the computer 800, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 800 are connected with a system bus 820.

Computer-readable instructions stored on a computer-readable medium are executable by the processing unit 802 of the computer 800, such as a program 818. The program 818 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 818 along with the workspace manager 822 may be used to cause processing unit 802 to perform one or more methods or algorithms described herein.

### Examples

1. A theft protection system for a device includes a cable having an inner optical waveguide and first and second ends, a locking mechanism to releasably securing the cable to the device and align the first end of the cable to a light emitter in the device and to align the second end of the cable to a light detector in the device such that severing the cable interrupts light transmission via the optical waveguide between the light emitter and light detector.

2. The system of example 1 wherein the locking mechanism includes a locking bolt actuated by a key to lock the locking mechanism to a chassis of the device.

3. The system of example 2 wherein the locking bolt includes a pair of latches extending orthogonal to the locking mechanism that are insertable into an opening of the chassis of the device in an unlocked position, and including latching portions extending laterally from each other and moveable laterally to expand beyond the opening of the chassis of the device to lock the locking mechanism to the chassis of the device.

4. The system of example 3 wherein the first and second ends of the cable are coupled to respective ones of the pair of latches and the latches include waveguide portions to optically align the waveguide portions with the light emitter and light detector in the locked position.

5. The system of any of examples 1˜4 wherein the waveguide is an optical fiber.

6. The system of any of examples 1-5 wherein the cable includes carbon steel strands arranged around the optical waveguide.

7. The system of any of examples 1-6 and further including circuitry coupled to the light detector to detect the presence and absence of light from the light emitter transmitted through the waveguide.

8. The system of example 7 wherein the circuitry is configured to perform operations including receiving a locked status indicating the locking mechanism is secured to the device, detecting the absence of a signal from the light detector, and performing an action in response to detecting the absence of a signal from the light detector.

9. The system of example 8 wherein performing an action in response to detecting the absence of a signal includes sounding an alarm or transmitting an alarm message.

10. The system of example 8 wherein performing an action in response to detecting the absence of a signal includes initiating a data protection action of encrypting data stored on the device or destroying the data stored on the device.

11. A theft protection system for a device includes a cable having an inner optical waveguide and first and second ends, a container configured to securely couple to the device, a light emitter supported within the container, a light detector supported within the container, and a locking mechanism to releasably securing the cable to the container to align the first end of the cable to the light emitter and to align the second end of the cable to a light detector such that severing the cable interrupts light transmission via the optical waveguide between the light emitter and light detector causing the light detector to provide an electrical signal representative of the interruption of light transmission.

12. The theft protection system of example 11 wherein the container is configured to couple to an outside of a chassis of the device.

13. The system of any of examples 11-12 wherein the locking mechanism includes a locking bolt actuated by a key to lock the locking mechanism to a chassis of the device.

14. The system of example 13 wherein the locking bolt includes a pair of latches extending orthogonal to the locking mechanism that are insertable into an opening of the chassis of the device in an unlocked position, and including latching portions extending laterally from each other and moveable laterally to expand beyond the opening of the chassis of the device to lock the locking mechanism to the chassis of the device.

15. The system of example 14 wherein the first and second ends of the cable are coupled to respective ones of the pair of latches and the latches include waveguide portions to optically align the waveguide portions with the light emitter and light detector in the locked position.

16. The system of any of examples 11-15 wherein the waveguide includes an optical fiber and wherein the cable comprises carbon steel strands arranged around the optical fiber.

17. The system of any of examples 11-16 and further including circuitry coupled to receive the electrical signal from the light detector representative of the absence of light from the light emitter transmitted through the waveguide, wherein the circuitry is configured to perform operations including receiving a locked status indicating the locking mechanism is secured to the device, detecting the absence of a signal from the light detector, and performing an action in response to detecting the absence of a signal from the light detector.

18. The system of example 17 wherein performing an action in response to detecting the absence of a signal includes sounding an alarm or transmitting an alarm message.

19. The system of example 18 wherein performing an action in response to detecting the absence of a signal includes initiating a data protection action of encrypting data stored on the device or destroying the data stored on the device.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A theft protection system for a device comprises:
a cable having an inner optical waveguide and first and second ends;
a locking mechanism to releasably securing the cable to the device and align the first end of the cable to a light emitter in the device and to align the second end of the cable to a light detector in the device such that severing the cable interrupts light transmission via the optical waveguide between the light emitter and light detector.

2. The system of claim 1 wherein the locking mechanism includes a locking bolt actuated by a key to lock the locking mechanism to a chassis of the device.

3. The system of claim 2 wherein the locking bolt comprises a pair of latches extending orthogonal to the locking mechanism that are insertable into an opening of the chassis of the device in an unlocked position, and including latching portions extending laterally from each other and moveable laterally to expand beyond the opening of the chassis of the device to lock the locking mechanism to the chassis of the device.

4. The system of claim 3 wherein the first and second ends of the cable are coupled to respective ones of the pair of latches and the latches include waveguide portions to optically align the waveguide portions with the light emitter and light detector in the locked position.

5. The system of claim 1 wherein the waveguide comprises an optical fiber.

6. The system of claim 1 wherein the cable comprises carbon steel strands arranged around the optical waveguide.

7. The system of claim 1 and further comprising circuitry coupled to the light detector to detect the presence and absence of light from the light emitter transmitted through the waveguide.

8. The system of claim 7 wherein the circuitry is configured to perform operations comprising:
receiving a locked status indicating the locking mechanism is secured to the device;
detecting the absence of a signal from the light detector; and
performing an action in response to detecting the absence of a signal from the light detector.

9. The system of claim 8 wherein performing an action in response to detecting the absence of a signal comprises sounding an alarm or transmitting an alarm message.

10. The system of claim 8 wherein performing an action in response to detecting the absence of a signal comprises initiating a data protection action of encrypting data stored on the device or destroying the data stored on the device.

11. A theft protection system for a device comprises:
a cable having an inner optical waveguide and first and second ends;
a container configured to securely couple to the device;
a light emitter supported within the container;
a light detector supported within the container; and
a locking mechanism to releasably securing the cable to the container to align the first end of the cable to the light emitter and to align the second end of the cable to a light detector such that severing the cable interrupts light transmission via the optical waveguide between the light emitter and light detector causing the light detector to provide an electrical signal representative of the interruption of light transmission.

12. The theft protection system of claim 11 wherein the container is configured to couple to an outside of a chassis of the device.

13. The system of claim 11 wherein the locking mechanism includes a locking bolt actuated by a key to lock the locking mechanism to a chassis of the device.

14. The system of claim 13 wherein the locking bolt comprises a pair of latches extending orthogonal to the locking mechanism that are insertable into an opening of the chassis of the device in an unlocked position, and including latching portions extending laterally from each other and moveable laterally to expand beyond the opening of the chassis of the device to lock the locking mechanism to the chassis of the device.

15. The system of claim 14 wherein the first and second ends of the cable are coupled to respective ones of the pair of latches and the latches include waveguide portions to optically align the waveguide portions with the light emitter and light detector in the locked position.

16. The system of claim 11 wherein the waveguide comprises an optical fiber and wherein the cable comprises carbon steel strands arranged around the optical fiber.

17. The system of claim 11 and further comprising circuitry coupled to receive the electrical signal from the light detector representative of the absence of light from the light emitter transmitted through the waveguide, wherein the circuitry is configured to perform operations comprising:
receiving a locked status indicating the locking mechanism is secured to the device;
detecting the absence of a signal from the light detector; and
performing an action in response to detecting the absence of a signal from the light detector.

18. The system of claim 17 wherein performing an action in response to detecting the absence of a signal comprises sounding an alarm or transmitting an alarm message.

19. The system of claim 18 wherein performing an action in response to detecting the absence of a signal comprises initiating a data protection action of encrypting data stored on the device or destroying the data stored on the device.
